(19) United States
(12) Patent Application Publication
(10) Pub. No.: US 2024/0250587 A1
(43) Pub. Date: Jul. 25, 2024

(54) METHOD FOR PRODUCING A STATOR AND STATOR

(71) Applicant: ADDITIVE I DRIVES GMBH, Dresden (DE)

(72) Inventor: Markus OETTEL, Dresden (DE)

(21) Appl. No.: 18/293,333

(22) PCT Filed: Jul. 22, 2022
(86) PCT No.: PCT/EP2022/070637

§ 371 Date: Jan. 29, 2024

(30) Foreign Application Priority Data
Jul. 27, 2021 (DE) 10 2021 119 414.8

(51) Int. Cl. H02K 15/00

(52) U.S. Cl. CPC H02K 15/0037

(57) ABSTRACT

Disclosed is a method of manufacturing a stator comprising a winding, preferably a hairpin winding, for an electric machine, in particular an electric motor or generator. The method includes introducing, in particular inserting, winding base bodies into stator slots and additively applying at least one section of at least one winding head, in particular by applying a build-up material in layers and locally selectively solidifying the build-up material by an irradiation with at least one beam impinging on the build-up material and stator.

The invention relates to a method for manufacturing a stator for an electrical machine, in particular an or for an electric motor or generator, as well as a corresponding stator.

Methods for manufacturing a stator for an electrical machine are generally known. For example, it is known to introduce solid copper wires (e.g. flat copper wires) into stator slots of the laminated sheet package using so-called hairpin technology.

Hairpins can replace windings that are produced using conventional winding processes such as needle winding. In particular, hairpins represent a different form and/or type of the windings. In particular, a hairpin can be produced with a wire, for example a solid copper wire, and/or by reshaping a wire.

The known methods for manufacturing a stator are considered to be fundamentally in need of improvement. In particular, the known methods are considered to be comparatively complex, especially due to the type, number and/or extent of forming operations required and/or forming tools, and/or they do not fulfil the requirements placed on the stator in the desired manner, especially with regard to installation space, thermal and/or electrical properties.

In general, the object with stators is to further optimise their parameters, particularly with regard to installation space, thermal and/or electrical properties, and also to design them flexibly. This is also due to the fact that electric motors are being used more widely, especially if they can fulfil the requirements placed on them, such as energy efficiency, flexibility and/or a limitation and/or reduction of the installation space required, to an improved extent.

In particular, the rapid provision of stators with modified properties is also an object that is increasingly arising or may arise in the manufacture of stators. In particular, it is an object of the invention to reduce type, number and/or scope of forming operations and/or forming tools required to manufacture a stator.

It is therefore the object of the invention to propose a method for manufacturing a stator for an electrical machine, in particular an electric motor or generator, wherein the manufacturing effort should be as low as possible and/or a comparatively high efficiency and/or good usability of the stator or a corresponding electrical machine in operation should nevertheless be achieved.

In particular, it is an object of the invention to reduce the thermal and/or electrical power loss in the stator and/or to reduce and/or minimise the required installation space for the stator.

At least one of these object is solved by the subject matter according to claim 1.

In particular, the at least one object is solved by a method for manufacturing a stator comprising at least one winding, preferably at least one hairpin winding for an electrical machine, in particular for an electric motor or generator, comprising the steps:
introducing, in particular inserting (or other introduction), of winding base bodies into stator slots and
additively applying at least one section of at least one winding head, in particular applying in layers of a build-up material and locally selectively solidifying the build-up material by irradiation with at least one beam impinging on the build-up material.

The at least one object is solved in particular by a method for manufacturing a stator, in particular for an electric motor or an electric generator, comprising at least the steps:
introducing, in particular inserting, additively introducing, additive manufacturing or other introduction of winding base bodies into stator slots, in particular of a winding support or stator blank, and
additively applying at least one section of at least one winding head to the winding base bodies, in particular additively applying exactly one or at least one winding head or of two winding heads, in particular within a single work step.

Preferably, the at least one section of the at least one winding head, the winding head or the winding heads is-are applied in such a way that the at least one winding is thereby formed in the stator.

The at least one object is solved in particular by a method for manufacturing a stator, in particular for an electric motor or an electric generator, comprising at least the steps:
additively manufacturing winding base bodies, in particular within a single work step and/or together with a first winding head,
introducing, in particular inserting or other introducing of the winding base bodies into stator slots, in particular of a winding support or stator blank, in particular within a single work step, and
additively applying at least one section of at least one winding head to the winding base bodies, in particular additively applying at least one winding head, preferably a second winding head, in particular within a single working step.

By the method according to the invention in particular the thermal and/or electrical power loss in the stator can be reduce and/or the installation space for the stator can be reduced or minimised. In addition, a fast, flexible and efficient production is possible.

In particular, the winding head can have connecting elements which are produced by an additive process, in particular by direct additive application to the winding base bodies, and/or in each case connect a first and a second winding base body in such a way that the height and/or the installation space of the winding head are minimised and/or reduced.

Preferably, at least one connecting element is formed essentially triangular in shape and/or extends at an angle, preferably of more than 120° and/or between 60° and 80° in relation to a longitudinal direction of the winding base body.

Preferably, at least one winding head is manufactured or produced entirely by additive application.

Additive application or manufacturing is understood in particular to mean manufacturing by 3D printing, in particular 3D copper printing, and/or by an additive printing process and/or a master moulding process. The elements and/or connections of the winding head are therefore preferably produced in one piece and directly in their final shape, in particular by applying build-up material in layers and preferably by selective solidification, preferably by means of a beam impinging on them, for example a laser beam.

Additive application is thus preferably understood to mean an application in layers of a component on an existing, prefabricated component, without the use of welded joints, in particular without the use of welded joints between two or more prefabricated components, and/or forming tools and/or tools in general. An application in layers means in particular the production or manufacture of a component by application in layers onto another existing component.

The winding head is preferably produced by means of a single manufacturing, working or process step.

Preferably, the additive application is carried out on the basis of data sets that define the respective geometries. These data sets are preferably generated in the design and/or by a CAD or CAE programme. These data records then control a 3D printing system that additively, in particular in layers, applies the build-up material, and preferably selectively solidifies it, thus producing at least one section of the at least one winding head and/or the laminated sheet package.

The stator is preferably manufactured in a two-stage process.

Thereby, in the first stage in particular, the active area of the stator with the winding support and its stator slots, the first winding head and the winding base bodies extending through the stator slots is produced. In the first stage, therefore, the stator laminated sheet package with the stator slots is preferably manufactured and the winding base bodies are introduced into the stator slots or additively manufactured at the same time as the stator laminated sheet package. In particular, the winding base bodies can be additively manufactured at least partially within the stator slots. The winding base bodies preferably also form the first winding head.

In the second stage, the second winding head opposite the first is then produced by additive application to the winding base bodies, whereby the winding base bodies can be interconnected in particular.

In one embodiment, both the first and second stages of manufacturing the stator are carried out by an additive process or comprise such a process.

In one embodiment, both the first and the second stage of manufacturing the stator comprise an additive process, wherein in the first stage the winding base bodies are manufactured, in particular, additively, which are subsequently inserted into the winding support in the axial direction. Alternatively, the winding base body and winding support can also be manufactured together in an additive process.

One idea of the invention is to separate the production of the winding head from the production of the corresponding winding base bodies in terms of the process on the one hand and to produce the winding heads by additive application (or an additive manufacturing process, for example laser sintering or laser melting) on the other hand, and by that in particular to improve the properties of the stator as a whole.

In particular, one idea of the invention is to produce at least one winding head at least essentially without formings, in particular by direct application to the winding base bodies. By this undesired changes in wall thickness, springbacks, elongations and/or material flow in the winding head, which otherwise arise or can arise in particular as a result of forming, can be avoided or reduced. In particular, a bending in the, in particular upper, area of the winding head is not necessary. In particular, a twisting, bunching and/or twisting in the, in particular upper and/or lower, area of the winding head and/or for connecting the winding head is also not required.

The fact that a bending and/or twisting is not required in the, in particular upper, area of the winding head can additionally reduce manufacturing costs and time, while at the same time the disadvantages associated with bending and/or twisting in terms of tolerances in the course of connecting elements and the deterioration of the conductivity are or can be reduced or avoided.

In addition, radii of connecting elements in the winding head can be minimised or set to zero or almost zero and/or cross-sections, distances and/or layer jumps can be specifically and precisely adapted by additive application. Furthermore, tolerances during manufacture are reduced, in particular with regard to the course and cross-sections of the connecting elements.

A further idea of the invention is to dispense with welding points and/or segmentations of the laminated sheet package. In particular, this can improve the electrical and magnetic properties of the laminated sheet package and thus also of the electrical machine as a whole. For example, dispensing with welding points in the area of the winding head, in particular for connecting the winding base bodies, can further improve the conductivity in the area of the winding head.

The effects that can be achieved with conventional production, in particular without additive application, only by segmenting the laminated sheet package, i.e. by producing the laminated sheet package in parts and subsequently joining them, are preferably retained. In particular, for example, the cross-section of the stator slots within the laminated sheet package can vary in the radial and/or axial direction of the stator, so that these have at least partially a smaller cross-section than the conductors guided through them. In addition, transition points, for example connections, can be realised within the laminated sheet package, in particular within the slots, which require a larger cross-section than the other conductor parts.

In particular, material changes and contact problems caused by welding can be reduced or avoided by this. At the same time, however, the flexibility to vary the winding base bodies, in particular with regard to their course and/or cross-sections, and to combine them with the winding head in a variable manner is retained. In particular, “welding” is understood to mean the inseparable joining of respectively existing components, for example of electrical conductors, using heat and/or pressure. In contrast to that, under an “additive application” is understood in particular an application on layers of build-up material, which is selectively solidified, in particular by means of a beam impinging on it, for example a laser beam. Preferably thus, with “welding” two existing components are joined, whereas with additive application, in particular a second component is applied in layers to an existing first component and is therefore preferably newly produced on it, in particular on the basis of a control of the solidification by a data set. In this respect, a “welding” in this sense should in particular not be understood as an additive manufacturing process.

Applications of the invention lie in particular in the field of prototyping and/or in series production.

In particular, a combination of conventional manufacturing (e.g. by manufacturing from winding blanks, which may possibly be formed, e.g. in the case of U-pins or may not be formed, e.g. in the case of I-pins) and additive manufacturing (e.g. by means of laser sintering or laser melting) takes place.

In one embodiment, at least one or several or all of the winding base bodies is/are partially or completely not manufactured by an additive manufacturing process, preferably by forming of a wire, in particular copper wire, and/or drawing from wire, in particular copper wire.

An introduction of a (respective) winding base body can occur in such a way that the winding base body is already assembled outside the slot and/or is not first built up in the slot.

In particular, the winding base bodies can be I-shaped or U-shaped.

Preferably, conventionally plugged stator blanks can be interconnected by printing a winding head (or both winding heads). In particular, winding blanks can comprise assembled, compound-filled and insulated (in particular by means of primary insulation) conductors in a stator laminated sheet package.

One and the same stator blank can thus be given a different behaviour (for example with regard to torque and/or revolution speed, etc.) through different interconnection. This makes it possible to develop a construction set that can produce a plurality of different electric motors on the basis of on one stator blank (by combining the same stator blank with different printed winding heads). This different interconnection is preferably produced exclusively digitally, in the design, in particular by variation of data sets for additive application, and/or without the use of physical tools. The data sets are preferably generated using a CAD or CAE program.

In addition, the winding base bodies can be specifically adapted, combined and/or varied in order to optimise the stator for a specific frequency behaviour, for example.

In one embodiment, the cross-sectional areas of individual winding base bodies can also be maximised for low frequencies. For example, a stator slot can be divided into segments running next to each other in the axial direction, wherein the or each winding base body at least essentially completely fills the respective segment. Preferably, in the embodiment, the stator is provided for operating frequencies of a current through the winding base bodies of at most 10 KHz.

In one embodiment, for high frequencies, the cross-section of one or each winding base body can be divided into at least two or at least three partial cross-sections which are electrically insulated from each other, in particular in order to reduce the current displacement inside the conductor, for example resulting from skin effects, and thus reduce the eddy-current losses. Preferably, in the embodiment, the stator is designed for operating frequencies of a current through the winding base bodies of at least 100 KHz.

Overall, a comparatively simple process is realised which nevertheless (at least partially) exploits the particular advantages of an additive manufacturing step.

In particular, the invention enables or can enable the following improvements in the manufacture of a stator:
Minimisation of installation space: in particular, the additive application of the at least one winding head or both winding heads enables a precise and/or compact application of the build-up material to the winding base bodies. Connecting elements in the winding head can be defined precisely or more precisely and with low tolerances and/or distances with regard to their own course and their course relative to other connecting elements.
Loss reduction: Electrical and/or thermal losses in the stator can preferably be reduced, as, particularly for connecting the winding head, neither welding points nor segmentations of the laminated sheet package nor bending or twisting processes are required. In addition, conductor cross-sections can be specifically and precisely adapted or increased at required points in order to reduce current densities there. Furthermore, conductor cross-sections can be adapted to the frequencies prevailing in the stator.
Flexibility of the interconnection: The additive application of the winding head enables a flexible interconnection of the winding base bodies, in particular by using layer jumps between different radial layers of the stator slots. In addition, the formation of endless windings is possible without the use of welding points or segmentations of the laminated sheet package, in particular in an at least partially closed stator slot or in several at least partially closed stator slots. In particular, the stator slot is not completely and/or exclusively closed but, for example, its cross-section is narrowed in a radial direction, in particular inwards. However, if, for example, a radially inner opening of a stator slot is smaller than the conductor cross-section, radial insertion is also not possible without additive manufacturing. Only open slots would make this possible, but these are less favourable in terms of electrical properties. Thus, an additive manufacturing also enables in this respect at least a more efficient production while maintaining the desired electromagnetic properties.
Flexible use of winding base bodies: Different winding base bodies can be combined in the stator in order to adapt the electrical properties specifically to the existing parameters, for example operating frequencies. In addition, different winding base bodies are flexibly interchangeable against each other.

A first winding base body and a second winding base body can be connected via connecting elements to form an endless loop and/or endless winding.

At least one winding base body can be arranged in an at least partially closed stator slot.

In particular, the stator slot can be at least partially closed towards at least one winding head and/or towards an inner side and/or on all sides.

In particular, a stator can comprise a first additively applied winding head, which is printed on a first front side of a cylindrical winding support or laminated sheet package. On the opposite front side preferably a second additively applied winding head is located, which is preferably also printed on the winding support.

Alternatively, a stator can comprise a single additively applied winding head, which is printed on winding base bodies on a first or second front side of a cylindrical winding support or laminated sheet package. On the opposite front side, preferably a second winding head is formed by winding base bodies having an arc, in particular essentially U-shaped or also V-shaped. These winding base bodies preferably extend with their legs through different stator slots, whereby these transition into the respective arcs on the opposite front side, on the second winding head.

The winding support, the stator blank or the laminated sheet package preferably comprises several stator slots, which preferably extend along a circumference of the winding support or the laminated sheet package, in particular in the axial direction. Winding base bodies can be arranged in different radial positions within the stator slots.

In particular, a direct additively application of connecting elements of the winding head to the ends of the winding base bodies takes place. In this way, the contact resistance between the ends of the winding base bodies and the connecting elements can be reduced or minimised, as neither welding points nor bends or twisting are required, and at the same time both the connection cross-section as well as the connection angle can be flexibly set.

In addition, the course of the connecting elements in the winding head can be set flexibly and with low tolerances.

In particular, it is possible to apply the entire winding head in a single work step, especially additively, so that restrictions due to sequential application or formation of the components of the winding head are avoided.

The required installation space can be reduced both in axial direction as well as in radial direction. Thus, in a winding head or stator according to the invention, both the installation height as well as the radial thickness can be reduced and/or adapted to the specific requirements, in particular by lesser tolerances and distances between the connecting elements and/or adaptation of cross-sections.

The invention also makes it possible to increase the portion of the active area of the stator in relation to its overall height or overall length. In particular, the active area is understood to be the space within the winding support or laminated sheet package. The total length of a stator is a balance or sum of length or height of the winding heads and the active length. An active length is understood in particular to be a length of the active area in the axial direction.

The associated electric motor or electric generator can in particular be an inrunner, whereby the inside running rotor can be designed as a passive armature. Alternatively, the associated electric motor or electric generator can be an outrunner.

In particular, the winding base bodies can be so-called hairpins. These can be manufactured either by bending from raw material or directly by an additive process, whereby they preferably have two legs that are essentially straight and parallel to each other and extend through the active area of the stator when installed.

The manufacturing by an additive process allows a targeted adaptation of the respective cross-section to the specific requirements. For example, the cross-section within the active area can be designed in such a way that it essentially completely fills the respective slots or the intended part of the slots. In addition, the connecting area between the two legs can be formed with a different, for example flat, cross-section.

Preferably, all hairpins of a stator are produced in a single additive work step and then inserted together into the winding support. The second winding head can then be applied additively in the second work step.

Alternatively, the hairpins can be combined to form a basket, whereby the hairpins can be bent from individual wires and joined together to form the basket.

The winding base bodies are preferably inserted into the winding support, the stator blank or the laminated sheet package in such a way that they end approximately flush with it at one front side, so that the winding head can then be applied additively.

The invention also enables an adaptation of the cross-sections in the stator to changing requirements at very short notice. In particular, by using the very same or the same, in particular identical, raw material, in particular raw material type a first stator with first electrical properties and/or cross-sections and directly afterwards a second stator with second electrical properties and/or cross-sections can be produced.

In particular, aluminium materials or aluminium powder, copper materials or copper powder, in particular pure copper, pure aluminium, aluminium alloys or copper alloys are used as raw materials. Preferably, the copper materials or copper powders used have a purity of more than 99.5%.

High-purity copper and/or high-purity aluminium preferably offer good electrical and thermal conductivity. Preferably, the tensile strength is at least 170 MPa and/or the yield strength is at least 120 MPa and/or the elongation at tear is more than 20%.

In particular for a double-sided application of a winding head by means of an additive manufacturing process, at least one of the winding base bodies can be U-shaped (or as a U-pin). A U-shaped winding base body is to be understood as a winding base body whose open ends are arranged at least essentially on the same side.

Alternatively or additionally, at least one of the winding base bodies (possibly several or all winding base bodies) can be I-shaped (or as an I-pin), preferably if on both sides a winding head is produced or manufactured by additive application. An I-shaped design of the corresponding winding base body is preferably to be understood as a winding base body whose open (before the connection) ends are arranged on opposite sides. The winding base body need not (but can) be straight.

In particular, the winding base bodies can comprise at least one conductor type, in particular different conductor types.

A first winding base body can be formed from a first conductor type and a second winding base body from a second conductor type that differs from the first conductor type.

The first winding base body and the second winding base body can be introduced radially and/or axially neighbouring with respect to a centre axis of the stator.

A winding base body can be formed in a first section from a first conductor type and in a second section, adjacent to the first section in axial/longitudinal direction, from a second conductor type that differs from the first conductor type.

The first conductor type can have a first conductivity and the second conductor type a second conductivity, so that ohmic losses during operation of the electrical machine are reduced by suitable variation of the conductivity.

The first conductor type can have a first cross-section/cross-section profile and the second conductor type can have a second cross-section/cross-section profile, so that thermal and/or electrical losses during operation of the electrical machine in sections with high current flow are reduced in a targeted manner.

The first conductor type can have a first number of parallel strands/conductors and the second conductor type can have a second number of parallel strands/conductors, so that preferably losses during operation of the electrical machine at high frequencies in required sections are reduced.

The connecting elements can have a third conductivity, cross-section/cross-section profile and/or number of parallel strands/conductors, at least in sections, so that preferably losses during operation of the electrical machine are reduced.

One conductor type can, in particular, be a stranded wire. Alternatively or additionally, at least one of the winding base bodies may comprise a stranded wire in at least one section, wherein the winding base body is formed in particular from a plurality, in particular at least 30, thin, preferably round, individual wires or cores extending along a longitudinal direction, in particular insulated from one another and/or by at least one layer of varnish and not specially layered, in particular with a diameter of at least 0.1 mm or at least 0.5 mm in each case.

Alternatively or additionally, at least one of the winding base bodies and/or conductor type can be produced at least in one section by an additive manufacturing process, wherein in a cross-section at least a second area has a lower conductivity than at least a first area.

The second area can comprise at least one gap, intermediate space or cavity that extends transversely through the cross-section and/or longitudinally through the winding base body, in particular along a straight line and/or plane, so that the winding base body is split into at least two partial winding base bodies.

The (respective) second area can be formed at least in sections by a cavity or intermediate space (preferably filled, e.g. gas-filled and/or filled with a liquid and/or solid material).

The (respective) second area can be introduced during the additive manufacturing by multi-material processing, for example in such a way that the respective first area(s) is/are provided by supplying a first material and the respective second area(s) is/are provided by supplying a different material, for example with lower conductivity.

Preferably, the at least one second area (possibly several or all second areas) is (are) formed electrically insulating, further preferably formed at least in sections by an electrically insulating material and/or formed at least in sections by a (e.g. gas-filled or air-filled) cavity. A cavity can be created by removing build-up material that is still in powder form. Openings can be provided for this purpose and/or for other reasons, as end areas are (otherwise) optionally completely closed (in particular sintered).

The (respective) second area can result from non-exposure or a different exposure. It can run from one layer plane to the next layer plane in such a way that at least a certain portion of the area is overlapping so that a continuous cavity (gap) is created. At least one second (possibly several or all second) area(s) can extend over at least 0.5 cm of the length of the conductor (or of the winding), possibly over at least 1.0 cm or at least 2.0 cm.

The partial winding base bodies can be electrically connected to each other only by the winding head.

The conductivities of the first areas and of the at least one second area to be compared should preferably be determined at a temperature of 20° C. The conductivity of at least one second area (possibly several or all second areas) is preferably at most 0.5 times, further preferably at most 0.1 times, still further preferably at most 0.001 times or at most 0.001 times as great as the electrical conductivity of at least (possibly several or all) first areas is preferably at least 0.1×10⁶ S/m, further preferably at least 1.0×10⁶ S/m, further preferably at least 20×10⁶ S/m and/or at most 200×10⁶ S/m or at most 100×10⁶ S/m. The conductivity of at least one second area (possibly several or all second areas) can be at most 1×10⁶ S/m, possibly at most 0.1×10⁶ S/m, further alternatively at most 1.0×10³ S/m, further alternatively at most 1.0 S/m, further alternatively at most 1.0×10⁻³ S/m, still further alternatively at most 1.0×10⁻⁶ S/m, still further alternatively at most 1.0×10⁻⁹ S/m and/or at least 1.0×10⁻²⁰ S/m, alternatively at least 1.0×10⁻¹⁵ S/m.

A conductor type can in particular be solid copper, a waveguide and/or a hairpin. Alternatively or additionally, at least one of the winding base bodies can be formed at least in one section from solid copper, hairpin and/or as a waveguide, whereby the winding base body can be formed in particular from a single copper core extending along a longitudinal direction, in particular with a (circular) round and/or flat and/or rectangular cross-section and/or as a flat wire and/or with an external diameter of at least 1.0 mm and/or with an internal diameter of at least 0.5 mm.

A conductor type can in particular be a transposed conductor (Roebelstab). Alternatively or additionally, at least one of the winding base bodies may comprise a transposed conductor (Roebelstab) at least in one section, wherein the winding base body is formed in particular from a plurality, in particular at least 10, of thin, in particular insulated against each other and specially layered, individual wires or cores extending along a longitudinal direction, preferably helically, in particular with a diameter of at least 0.4 mm.

In embodiments, only one winding head (particularly in the case of U-shaped winding base bodies) may be realised by additive application (production). Alternatively, both winding heads can also be produced, at least in sections, by additive application, in particular by applying a build-up material in layers and additive solidification of the build-up material by an irradiation with at least one beam impinging on the build-up material, in particular in the case of I-shaped winding base bodies.

The winding base bodies are preferably spread (against each other) at their ends (in particular directly adjacent to a slot liner or insulating paper (or: slot insulation), which is arranged in the stator slot).

A spreading can be realised in that the winding base bodies are already produced in a mould so that they are spread (against each other) or spread away from each other after being arranged in the corresponding slot. Alternatively or additionally, the winding base bodies can be spread at their ends (in particular directly adjacent to the slot liner) (in a separate step, after arrangement/insertion into the stator slot, in particular prior to the additive application of the corresponding winding head). By such a spreading (or spreading the conductor ends away from each other) the additive manufacturing of the winding heads can be simplified. For example, adjacent conductor sections (copper conductor sections) can be protected from the energy input during the additive manufacturing process. Furthermore, a certain tolerance compensation can be guaranteed in the event of fluctuations in a joining zone. In addition, optional post-processing steps can be facilitated by an improved accessibility (for example in the case of a surface processing and/or an insulation).

Preferably, the spreading begins directly adjacent, if possible, to a slot liner (or to one end of the respective slot liner), in particular to lose as little winding head height as possible. The spreading can be created directly during the manufacturing process (for example in an additive manufacturing process of the winding base body) or by a mechanical forming (either before or after the introduction into the stator slot). A slot liner can be understood in particular as an insulating paper or slot insulation. The slot liner is intended in particular to electrically insulate the laminated sheet package from the winding base bodies.

In one embodiment, the winding base bodies are spread against or towards each other at at least one of their ends. Preferably, the winding base bodies that are spread against or towards each other have a distance of at least 0.5 mm, preferably at least 1.0 mm, from each other at their ends.

In one embodiment, the winding base body section in which the winding base bodies are spread against or towards each other has a height of at least 5 mm, preferably of at least 10 mm, in the axial direction.

In one embodiment, a winding base body section in which the winding base bodies are not spread against or towards each other has a protrusion in the axial direction of at least 5 mm, preferably at least 10 mm, in relation to the stator blank or laminated sheet package.

In one embodiment, the winding base bodies have a protrusion in the axial direction of at least 10 mm, preferably at least 20 mm, to the stator blank or laminated sheet package.

In general, the winding base bodies can be produced by drawing and/or forming of, possibly drawn, blanks and/or an additive manufacturing process. Combinations are also conceivable in which the winding base bodies are produced partly by forming a blank and partly by an additive manufacturing process. It is also conceivable that at least one winding base body is produced by (conventional) forming and at least one winding body is produced by an additive manufacturing process.

Preferably, the winding (particularly in the area of the winding head) has a changing cross-section. For example, the cross-section can increase (at least in sections) and/or decrease (at least in sections) and/or change its shape (at least in sections). Particularly preferably, a cross-sectional area remains constant, whereby the shape of the cross-section changes. Alternatively, a cross-sectional shape can remain constant, whereby the cross-sectional area changes. Further alternatively, both the cross-sectional area as well as the cross-sectional shape can change. In particular, by this, space can be gained between the individual conductor sections so that less forming work is required, for example. The dimensions of the conductor (or the winding as a whole) can thus be adjusted advantageously.

The additive application also allows a course of connectors along one layer at a time with intermediate layer jump.

In one embodiment, several at least essentially identical stator blanks can be produced, which are provided with different winding heads. By this different stator structures or stator types, which are preferably optimised for specific applications can be produced in a comparatively easy manner.

Ends of the winding base bodies can be levelled (or brought to a common plane), in particular by milling, and/or cleaned prior to additive application. By this a subsequent additive application of the winding head structures can take place in a particular easy manner.

A position and/or expansion or shape of ends of the winding base bodies can be determined by a, e.g. optical, measuring device prior to the additive application. By this a precise additive manufacturing process is enabled in an easy manner.

The above mentioned object is also solved in particular by a stator, comprising a winding, preferably a hairpin winding, for an electrical machine, in particular an electric motor or generator, manufactured according to the above method.

The above mentioned object is furthermore solved in particular by an electrical machine, in particular an electric motor or generator, comprising the above stator. Further embodiments arise from the dependent claims.

The object is solved in particular by a stator, in particular for an electric motor or for an electric generator, wherein the stator comprises
a winding support with stator slots for introducing and/or supporting winding base bodies and/or windings,
winding base bodies introduced, in particular inserted (or otherwise introduced), into the stator slots, and
at least one winding head with at least one additively applied section, in particular at least one additively applied winding head or two additively applied winding heads.

Preferably, the at least one section of the at least one winding head, the winding head or the winding heads is/are applied in such a way that the at least one winding is thereby formed in the stator.

The invention is described below with reference to execution examples, which are explained in more detail with reference to the figures. Hereby show:

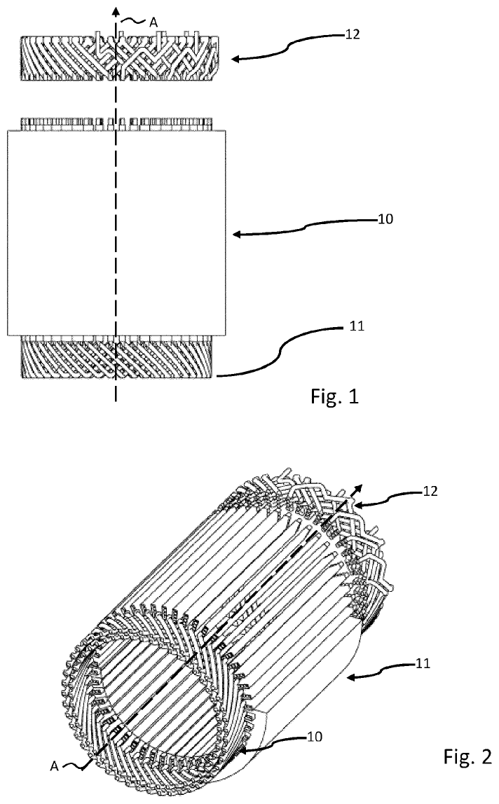

FIG. 1 a schematic representation of an embodiment of a stator (partially in exploded view);

FIG. 2 a schematic representation of a further embodiment of a stator (partially in exploded view);

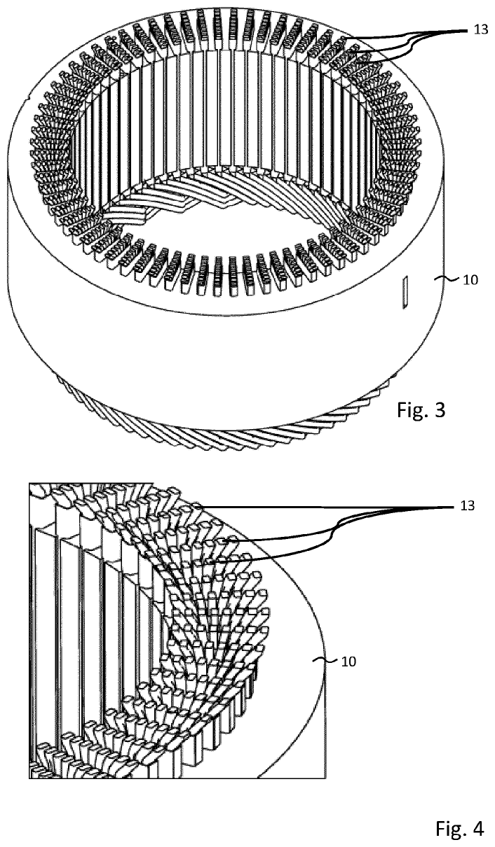

FIG. 3 a section of a stator blank (without winding head);

FIG. 4 a further sectional representation of a stator blank (without winding head);

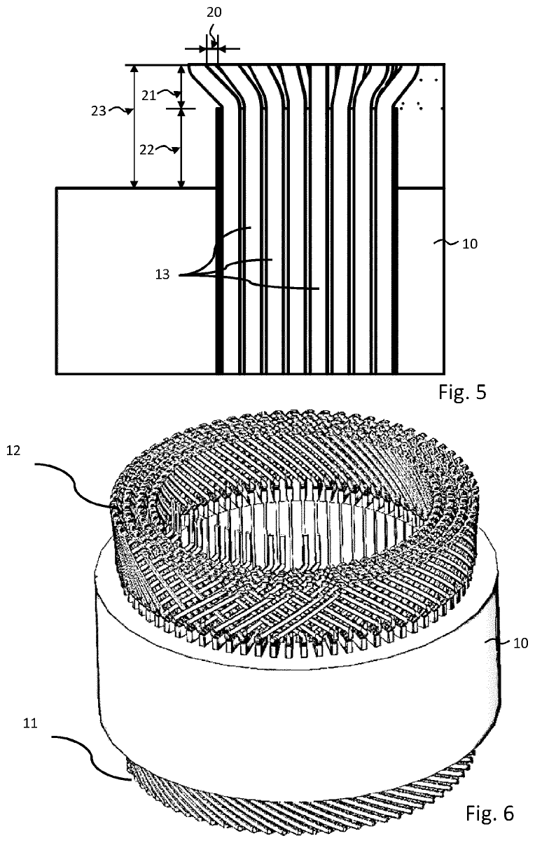

FIG. 5 a schematic representation of winding base bodies;

FIG. 6 a schematic oblique representation of a stator with winding head;

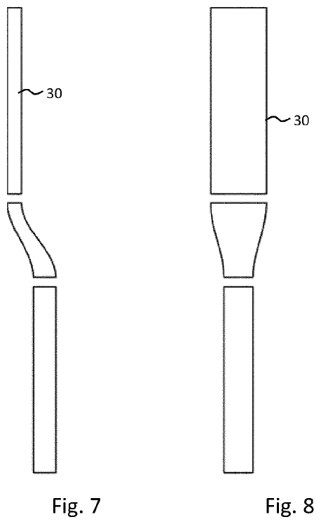

FIG. 7 a schematic representation of a conductor according to one embodiment in a first side view;

FIG. 8 the conductor according to FIG. 7 in a second side view;

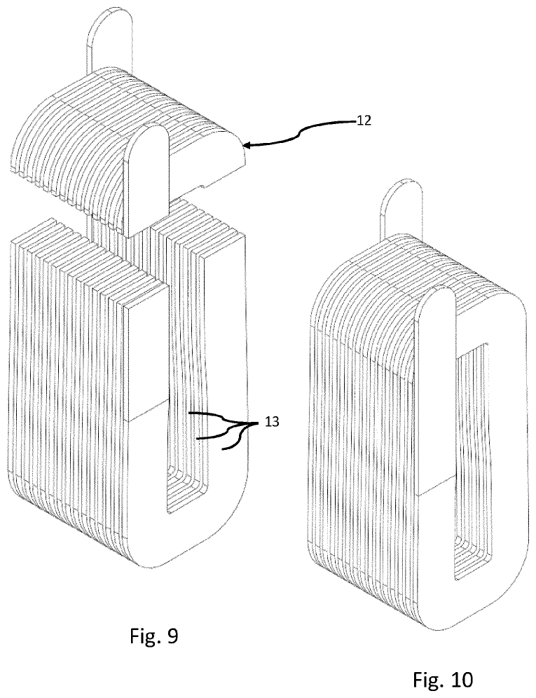

FIG. 9 a schematic view of a single coil (partially in exploded view);

FIG. 10 the single coil according to FIG. 9.

In the following description, the same reference numbers are used for identical and identically acting parts.

FIG. 1 shows a schematic representation of a stator according to one embodiment. This has a (possibly conventionally manufactured) stator blank 10 with a first winding head 11. The stator blank 10 itself does not have a second winding head. The second winding head 12 is only then printed (as alluded to in FIG. 1) by an additive manufacturing process (in particular laser sintering).

A in generally similar solution is shown in FIG. 2. In contrast to FIG. 1, however, both the first winding head 11 as well as the second winding head 12 are printed (double-sided) on the stator blank 10.

In FIG. 3 a section of a stator blank 10 can be seen with (at this stage of manufacture) open ends of winding base bodies 13 (see also FIG. 5). These are or will be (prior to the step of additively applying the winding head or the winding heads) spread, as can be seen in particular in FIGS. 4 and 5. In FIG. 6 then the stator blank with the printed winding head (or winding heads) can be seen.

In embodiments, the spreading begins directly adjacent to (above or below) a slot liner (not recognisable in the figures) or insulating paper. The spreading can, for example, be produced directly by an additive manufacturing process (3D printing) or mechanical forming.

In one embodiment, the winding base bodies 13, which are spread against or towards each other at their ends, have a distance 20 of at least 0.5 mm, preferably at least 1.0 mm, from each other at their ends.

In one embodiment, the winding base body section in which the winding base bodies 13 are spread against or towards each other has a height 21 of at least 5 mm, preferably of at least 10 mm, in the axial direction.

In one embodiment, a winding base body section in which the winding base bodies 13 are not spread against or towards each other has a protrusion 22 of at least 5 mm, preferably of at least 10 mm, in the axial direction in relation to the stator blank or laminated sheet package 10.

In one embodiment, the winding base bodies 13 have a protrusion 23 of at least 10 mm, preferably of at least 20 mm, in the axial direction relative to the stator blank or laminated sheet package.

The stator blank 10 or the (open) ends of the winding base bodies 13 are preferably (if necessary after impregnation) milled in order to realise a surface that is as flat as possible for printing the respective winding head. This can be followed by a cleaning in order to prevent that inclusions are created in a joining zone. After that a calibration on or in an AM arrangement or AM machine (AM for: additive manufacturing) can take place.

The winding base bodies 13 and/or the winding heads for that matter comprise conductors, in particular copper conductors. In particular, the conductors can be additively manufactured.

The conductor measurements can be (advantageously) influenced in particular in order to gain space between the individual conductors and thus require less forming work.

A conventional wire has a constant cross-section due to the manufacturing process. By the additive manufacturing process the external dimensions of the copper conductor can be changed (or the cross-section be changed). Thereby a cross-sectional area can remain constant, increase or decrease. An example in which the cross-sectional area remains constant (but which is not mandatory) but the cross-sectional shape and position changes is illustrated in FIGS. 7 and 8. For example (see FIG. 7), a cross-section of the conductor 30 (in the drawing plane from bottom to top) may decrease when viewed from a first side (within a transformation zone). At the same time (or alternatively), the conductor 30 may also have bends and/or angles or kinks. Furthermore, the same conductor 30 can enlarge in one direction (in the drawing plane from bottom to top) from a second (side view rotated by 90°), so that overall the cross-sectional area remains constant. Alternatively, the cross-sectional area can optionally also change.

FIGS. 9 and 10 show a single coil (partially in exploded view in FIG. 9), which can be manufactured as follows. First, a plurality of winding base bodies 13 are manufactured or provided. The winding base bodies 13 are preferably formed here as (in particular U-shaped) sheets. A connection (interconnection) of the winding base bodies 13 in the area of a second winding head 12 is preferably carried out by an additive manufacturing process (in particular laser sintering). Specifically, (e.g. cut) sheets can be assembled and an interconnection subsequently printed on.

At this point, it should be noted that all the parts described above are claimed to be essential to the invention when viewed individually and in any combination, in particular the details shown in the drawings. Modifications thereof are familiar to the skilled person.

Furthermore, it is pointed out that the broadest possible scope of protection is sought. In this respect, the invention defined in the claims can also be specified by features that are described with further features (even without these further features necessarily being included). It is explicitly pointed out that round brackets and the term “in particular” are intended to emphasise the optionality of features in the respective context (which does not mean, conversely, that a feature is to be regarded as mandatory in the corresponding context without such identification).

### REFERENCE SIGNS

10 stator blank
11 first winding head
12 second winding head
13 winding base body
20 distance
21-23 heights
30 conductor
A axial direction

1. Method of manufacturing a stator comprising a winding, for an electrical machine, comprising:
introducing at least one winding base body into stator slots; and
additively applying at least one section of at least one winding head by applying a build-up material in layers and locally selectively solidifying the build-up material by irradiation with at least one beam impinging on the build-up material.

2. (canceled)

3. (canceled)

4. The method according to claim 1, wherein the at least one winding base body is spread at its ends immediately adjacent to a slot liner before the additive application.

5. The method according to claim 1, wherein the at least one winding base body is produced by drawing and/or by forming of blanks and/or an additive manufacturing process.

6. The method according to claim 1, wherein the winding in an area of the winding head has a changing cross-section.

7. (canceled)

8. The method according to claim 1, wherein ends of the at least one winding base body is levelled by milling, and/or cleaned before the additive application.

9. The method according to claim 1, wherein the introduction is performed by insertion of the at least one winding base body into stator slots of a stator blank, and wherein the stator blank is or comprises a laminated sheet package and/or winding support.

10-13. (canceled)

14. The method according to claim 1, wherein the stator slots are at least partially closed towards at least one winding head and/or towards an inner side of a stator or stator blank and/or on all sides.

15. The method according to claim 1, wherein a direct additive application of connecting elements of the winding head to the ends of the at least one winding base body takes place, so that the contact resistance between the ends of the winding base bodies and the connecting elements is reduced or minimized.

16. The method according to claim 1, wherein the entire winding head is applied within a single working step, additively, in such a way that restrictions due to sequential application or formation of the components of the winding head are avoided.

17. (canceled)

18. (canceled)

19. The method according to claim 1, wherein the winding base bodies are produced by bending from raw material or directly by an additive process.

20. The method according to claim 1, wherein the at least one winding base body is or comprises hairpins.

21. The method according to claim 1, wherein the hairpins or at least one winding base body is/are combined to form a basket before introduction and/or wherein the hairpins are bent from individual wires and joined together to form the basket.

22-29. (canceled)

30. A method according to claim 1, wherein a winding base body is formed in a first section from a first conductor type and in a second section, adjacent to the first section in the axial or longitudinal direction of the stator, from a second conductor type which differs from the first conductor type.

31. A method according to claim 30, wherein the first conductor type has a first conductivity and the second conductor type has a second conductivity which differs from the first conductivity, so that losses during operation of the electrical machine are reduced.

32. (canceled)

33. A method according to claim 1, wherein a cross-section of at least one conductor type within an active area of the stator is designed such that it completely or substantially completely fills the respective slots or the intended part of the slots of the stator.

34. A method according to claim 1, wherein the winding base bodies are spread at least one of their ends against or towards each other, wherein in particular the spread winding base bodies have a distance of at least 1.0 mm from each other at the ends.

35. A method according to claim 1, wherein the winding base body section, in which the winding base bodies are spread against or towards each other, has a height of at least 10 mm in the axial direction of the stator.

36. A method according to claim 1, wherein a winding base body section, in which the winding base bodies are not spread against or towards each other, has a protrusion with respect to the stator blank or laminated sheet package of at least 10 mm in the axial direction of the stator.

37. A method according to claim 1, wherein the winding base bodies have a protrusion with respect to the stator blank or laminated sheet package of at least 20 mm in the axial direction of the stator.

38. A stator comprising a winding for an electric machine manufactured according to the method of claim 1.
